(19) United States
(12) Patent Application Publication
(10) Pub. No.: US 2017/0228902 A1
(43) Pub. Date: Aug. 10, 2017

(54) INFORMATION PROCESSING APPARATUS AND INFORMATION PROCESSING METHOD

(71) Applicant: CANON KABUSHIKI KAISHA, Tokyo (JP)

(72) Inventor: Yasuhiro Yoshimura, Tokyo (JP)

(21) Appl. No.: 15/409,768

(22) Filed: Jan. 19, 2017

(30) Foreign Application Priority Data
Feb. 10, 2016 (JP) 2016-023639

(51) Int. Cl. G06T 11/40; G06T 7/90

(52) U.S. Cl. CPC G06T 11/40; G06T 7/90; G06T 2210/62; G06K 15/1803

(57) ABSTRACT

Provided is an information processing apparatus including: a PDL analysis unit that acquires an output resolution of input PDL data when a tile drawing instruction is included in the PDL data, and calculates a drawing size of a tile drawing based on the tile drawing instruction and the output resolution; an average color calculation unit that calculates an average color of the tile drawing based on the tile drawing instruction when the calculated drawing size is smaller than a predetermined value; and a rendering unit that renders the tile drawing instruction based on the calculated average color. The average color calculation unit calculates the average color based on a transparency level of a unit tile included in the tile drawing instruction.

### BACKGROUND OF THE INVENTION

Field of the Invention

The present invention relates to a PDL drawing processing apparatus and method for generating raster data by using data described in a page description language (PDL) as input data.

Description of the Related Art

In general, PDL drawing processing for generating raster data by using PDL data for describing a drawing instruction as input can be divided into PDL analysis processing and rendering processing. In the PDL analysis processing, the PDL data is analyzed and converted into a drawing command having a lower level of abstraction. In the rendering processing, the drawing command is received, and processing for conversion into device coordinates and color compositing processing are conducted to create raster data. The raster data is output onto paper by a printer device or displayed on a monitor device. Existing examples of the PDL data include an XML paper specification (XPS) being a page description language of Microsoft Corporation and a portable document format (PDF) being a page description language of Adobe Systems Incorporated. The XPS and the PDF have a tile drawing instruction to conduct drawing by repeating the same drawing instruction once or more.

With the tile drawing instruction, it is possible to specify a width and a height of a tile (area being a unit of repetition) and an area to be covered by the tiles. The width and the height of the tile are specified in units of a coordinate system defined in PDL (hereinafter referred to as “PDL coordinates”). For example, the coordinate system of the XPS is defined as having the origin at the top left and units of 1/96 inch. The PDL coordinates are converted into coordinates defined by a device (hereinafter referred to as “device coordinates”) in a case of being converted into raster data to be output and displayed on the device in drawing processing. In general, the device coordinates are represented in units of pixels with the origin at the top left in a case of a printer.

In the conversion from the PDL coordinates into the device coordinates, which is included in the drawing processing, there are some cases where a content of the drawing specified as an integer in the PDL coordinates cannot be expressed in pixels due to the specification of an output size or a resolution. In order to solve this problem, in an XPS specification (ECMA-388), it is recommended to fill one tile with an average color of drawing results within the one tile when a drawing size of one tile drawing instruction becomes smaller than one pixel in a device coordinate system.

However, the related art, for example, a technology disclosed in Japanese Patent Application Laid-Open No. 2008-23960, in which a drawing using a mask pattern of a checkered pattern is converted into a drawing with an alpha channel, cannot be applied to a tile drawing including a drawing other than the mask pattern of the checkered pattern. Moreover, in a technology disclosed in Japanese Patent Application Laid-Open No. H08-235367, an interpolation method is determined based on a transparency level of a shading drawing instruction and a relation between a pixel of interest in a sub pixel level and a neighboring pixel, but the technology cannot be applied to a tile drawing including a drawing other than a shading.

In order to conduct accurate output when the drawing size of one tile drawing instruction becomes smaller than one pixel in the device coordinate system and a tile drawing has transparency, it is necessary to fill a tile drawing portion with an average color after temporarily conducting partial rendering with a resolution higher than an actual output resolution. However, it is necessary to conduct compositing processing with a background color taken into consideration, and overall processing becomes more complicated, which raises a problem in terms of performance.

### SUMMARY OF THE INVENTION

In order to solve the above-mentioned problems, according to one embodiment of the present invention, there is provided an information processing apparatus, including: a PDL analysis unit that acquires an output resolution of input PDL data when a tile drawing instruction is included in the PDL data, and calculates a drawing size of a tile drawing based on the tile drawing instruction and the output resolution; an average color calculation unit that calculates an average color of the tile drawing based on the tile drawing instruction when the calculated drawing size is smaller than a predetermined value; and a rendering unit that renders the tile drawing instruction based on the calculated average color, in which the average color calculation unit calculates the average color based on a transparency level of a unit tile included in the tile drawing instruction.

According to the present invention, when the drawing size of the tile drawing instruction becomes smaller than one pixel in a device coordinate system and a tile drawing has transparency, an output result equivalent to that of a case where the tile drawing is enlarged and rendered to thereafter be filled with an average color can be obtained with a calculation amount smaller than in the related art.

Further features of the present invention will become apparent from the following description of exemplary embodiments with reference to the attached drawings.

### BRIEF DESCRIPTION OF THE DRAWINGS

FIG. 1 is a diagram for illustrating an outline of an information processing apparatus according to an embodiment of the present invention.

FIG. 2 is a diagram for illustrating a processing configuration according to the embodiment of the present invention.

FIG. 3 is a diagram for illustrating an example of tile drawing.

FIG. 4A and FIG. 4B are diagrams for illustrating examples of applying enlargement and reduction to a tile drawing.

FIG. 5A, FIG. 5B, and FIG. 5C are diagrams for illustrating examples of calculating an average color of the tile drawing.

FIG. 6A and FIG. 6B are diagrams of examples of drawing a unit tile.

FIG. 7 is a diagram for illustrating an example of PDL data including the tile drawing.

FIG. 8 is a diagram for illustrating an example of a data structure that expresses a drawing instruction for the tile drawing.

FIG. 9 is a flowchart for illustrating rendering processing for a tile instruction according to the embodiment of the present invention.

FIG. 10 is a flowchart for illustrating tile average color determining processing according to the embodiment of the present invention.

FIG. 11 is a flowchart for illustrating tile average color determining processing using a calculation method I according to the embodiment of the present invention.

FIG. 12 is a flowchart for illustrating tile average color determining processing using a calculation method II according to the embodiment of the present invention.

### DESCRIPTION OF THE EMBODIMENTS

Now, an embodiment of the present invention is described in detail with reference to the attached drawings. In this embodiment, an XML paper specification (XPS), a portable document format (PDF), or the like is assumed as PDL data. In the following description, an “alpha value” represents a value indicating a transparency level of a color, and is assumed in this embodiment to be expressed by numerical values of from 0.0 (totally transparent) to 1.0 (totally opaque).

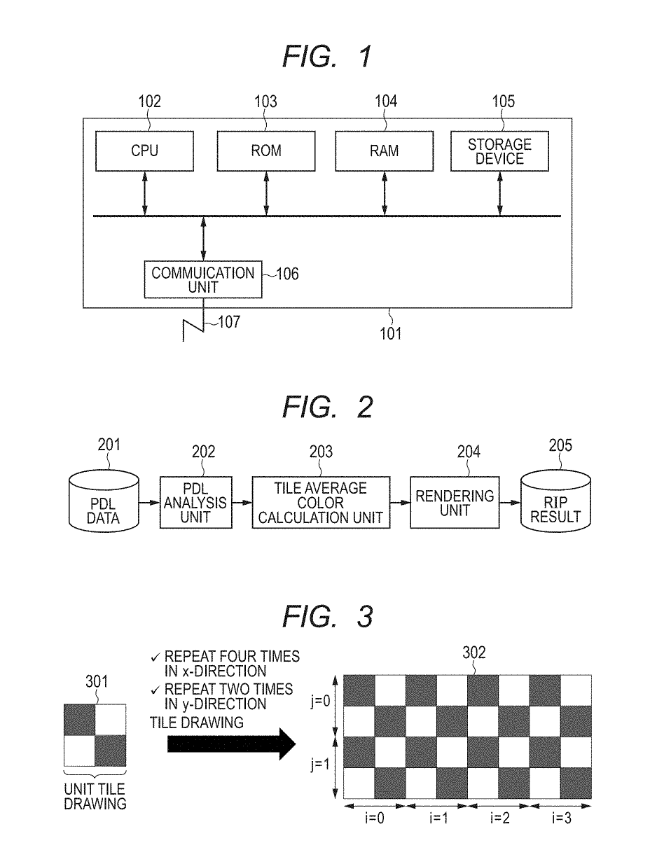

FIG. 1 is a diagram for illustrating an outline of an information processing apparatus 101 according to this embodiment. A CPU 102 is a central processing unit configured to control the entire information processing apparatus 101, and centrally controls a processing sequence of the information processing apparatus 101. Programs for achieving flowcharts described later and fixed data are stored in a ROM 103, and a RAM 104 is used for temporarily storing data and loading a program. Data stored in a storage device 105 can be held even when the information processing apparatus 101 is in a power-off state, and the storage device 105 allows the stored data to be read after reboot of the information processing apparatus 101. A communication unit 106 is used to transmit and receive data to/from an external device through a network 107.

FIG. 2 is a diagram for illustrating rendering processing conducted by the information processing apparatus 101. A PDL analysis unit 202 is configured to analyze a drawing instruction stored in input PDL data 201. A tile average color calculation unit 203 is configured to calculate an average color of a tile from the drawing instruction analyzed by the PDL analysis unit 202, and to replace the drawing instruction. A rendering unit 204 is configured to render the drawing instruction replaced by the tile average color calculation unit 203, and to generate an RIP result 205. At this time, the RIP result 205 may be held in the RAM 104 or the storage device 105.

FIG. 3 is a diagram for illustrating an example of tile drawing based on the PDL data. In PDL, a tile drawing instruction can specify a unit tile drawing (drawing instruction being a unit of repetition) and the numbers of repetitions (both in an x-direction and in a y-direction). In the example of FIG. 3, a drawing result 302 is obtained when a unit tile drawing 301 is repeated four times in the x-direction and two times in the y-direction.

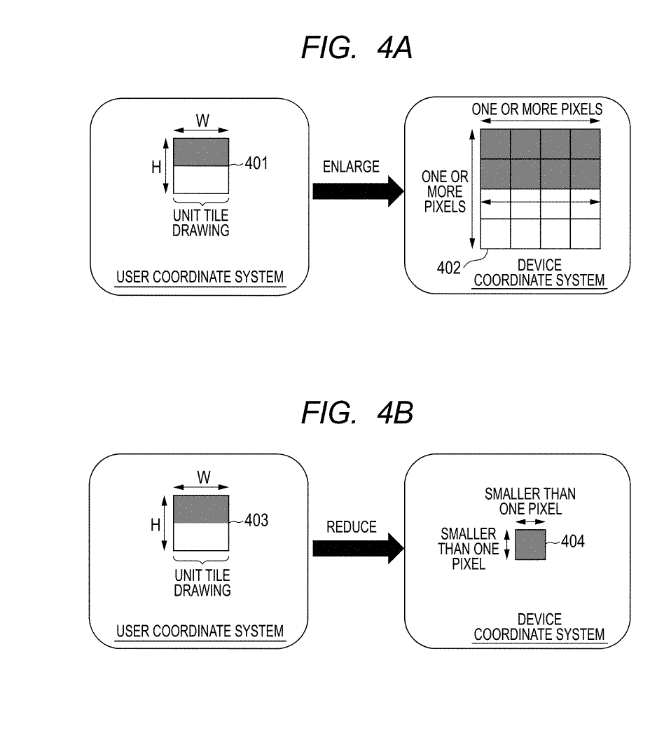

FIG. 4A and FIG. 4B are diagrams for illustrating examples of applying enlargement and reduction to a tile drawing. FIG. 4A is the example of a case of enlarging the tile drawing, and FIG. 4B is the example of a case of reducing the tile drawing. In the example of FIG. 4A, a unit tile 401 has a size of W and H in the x-direction and the y-direction, respectively, of a user coordinate system. When the unit tile 401 is enlarged, a drawing result 402 having a size equal to or larger than a predetermined value (one pixel) in the device coordinate system is obtained. In the example of FIG. 4B, a unit tile 403 has a size of W and H in the x-direction and the y-direction, respectively, of the user coordinate system. When the unit tile 403 is reduced, a drawing result 404 having a size smaller than the predetermined value (one pixel) in the device coordinate system is obtained. At this time, the drawing size of one tile drawing instruction becomes smaller than the predetermined value (one pixel) in the device coordinate system, and hence the drawing result 404 after the reduction is drawn in the average color of the unit tile 403.

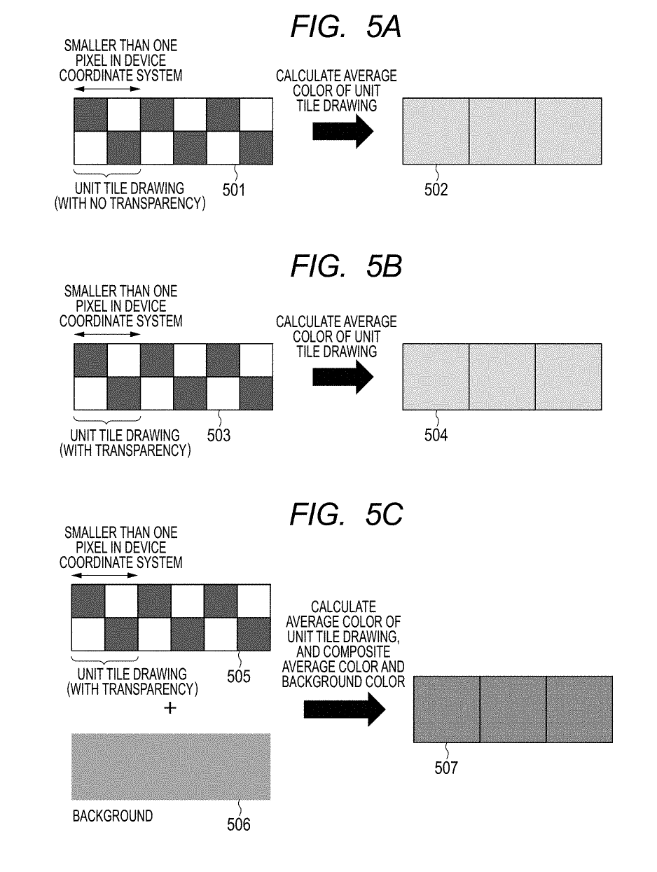

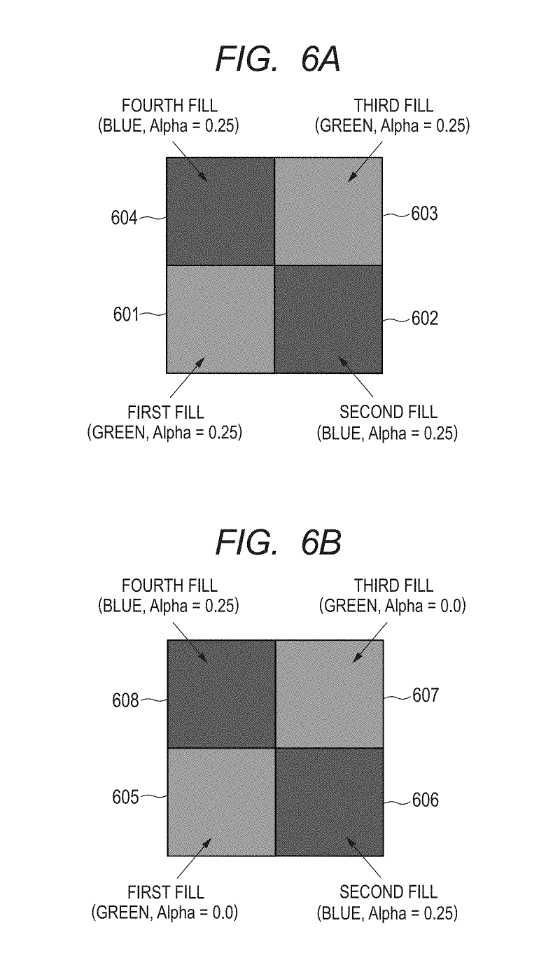

FIG. 5A, FIG. 5B, and FIG. 5C are diagrams for illustrating examples of calculating the average color of the tile drawing. FIG. 5A is the example of a case where a drawing within one tile has no transparency, FIG. 5B is the example of a case where a drawing within one tile has transparency, and FIG. 5C is the example of a case where a drawing within one tile has transparency and also has a background color.

In the example of FIG. 5A, the average color of the drawing instruction included in a unit tile 501 is calculated because the unit tile 501 has a size smaller than one pixel in the device coordinate system, and the unit tile 501 is filled with the average color as one tile (502). In the example of FIG. 5B, the average color of the drawing instruction included in a unit tile 503 is calculated because the unit tile 503 has a size smaller than one pixel in the device coordinate system, and the unit tile 503 is filled with the average color as one tile (504). In the example of FIG. 5C, the average color of the drawing instruction included in a unit tile 505 is calculated because the unit tile 505 has a size smaller than one pixel in the device coordinate system, and the tile in the average color and a background 506 are composited to be drawn (507).

FIG. 6A and FIG. 6B are diagrams for illustrating examples of drawing a unit tile. FIG. 6A is the example of a unit tile formed of only fills having the same alpha value, and FIG. 6B is the example of a unit tile formed of fills having different alpha values. In the example of FIG. 6A, the unit tile is formed of four fill instructions including a first fill (601), a second fill (602), a third fill (603), and a fourth fill (604). The first fill (601) and the third fill (603) are green (#00FF00) and have an alpha value of 0.25. The second fill (602) and the fourth fill (604) are blue (#0000FF) and have an alpha value of 0.25. Therefore, in the example of FIG. 6A, all the fills within the unit tile have the same alpha value.

In the example of FIG. 6B, the unit tile is formed of four fill instructions including a first fill (605), a second fill (606), a third fill (607), and a fourth fill (608). The first fill (605) and the third fill (607) are green (#00FF00) and have an alpha value of 0.0. The second fill (606) and the fourth fill (608) are blue (#0000FF) and have an alpha value of 0.25. Therefore, in the example of FIG. 6B, different alpha values of 0.0 and 0.25 exist within the unit tile.

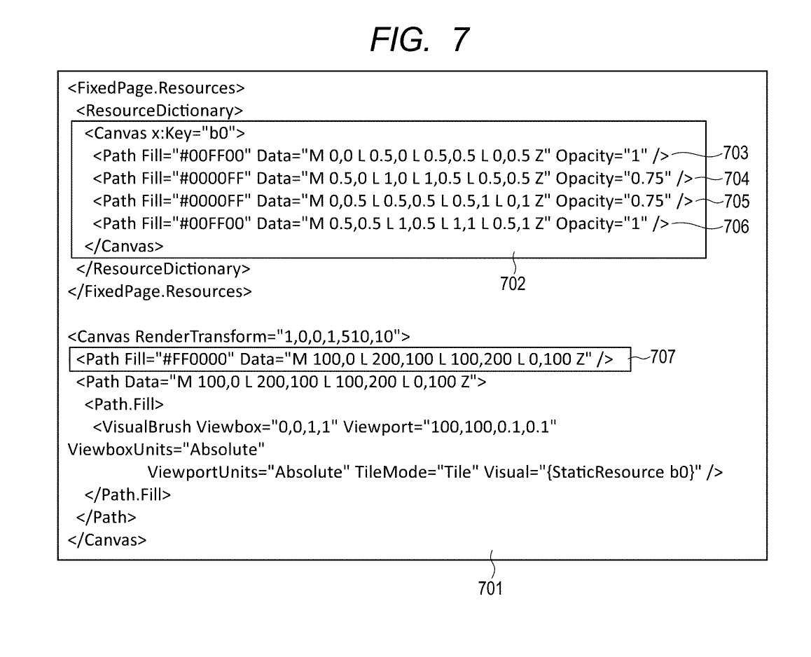

FIG. 7 is a diagram for illustrating an example (701) of the PDL data having a tile drawing. In this example, a unit tile 702 is formed of fills 703 to 706. The first fill (703) and the third fill (706) are green (#00FF00) and have an alpha value of 0.0. The second fill (704) and the fourth fill (705) are blue (#0000FF) and have an alpha value of 0.25. A fill 707 is a background in red (#FF0000).

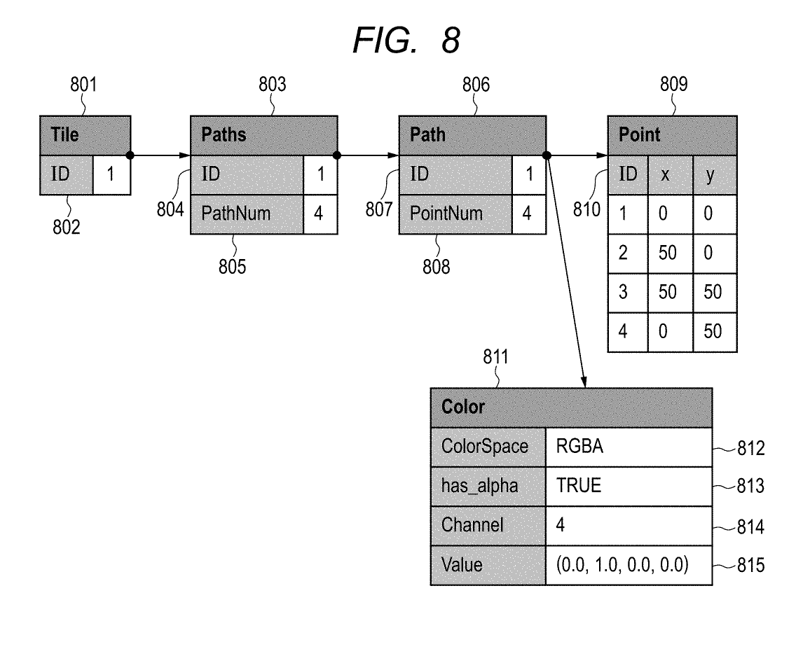

FIG. 8 is a diagram for illustrating an example of a data structure that expresses the drawing instruction for the tile drawing. Tile drawing data 801 holds an ID 802 for uniquely identifying a tile and configuration path group data (Paths) 803. The configuration path group data 803 holds an ID 804 for uniquely identifying a path group and a number (PathNum) 805 of paths that form the path group. Configuration path data (Path) 806 holds an ID 807 for uniquely identifying a path, a number (PointNum) 808 of vertices that form the path, configuration vertex data (Point) 809, and color information (Color) 811 on the path. The configuration vertex data 809 holds an ID 810 for uniquely identifying a vertex and coordinate values of the vertex. The color information 811 on the path has a color space (ColorSpace) 812, a flag (has alpha) 813 indicating whether or not an alpha value is included, a number (Channel) 814 of channels, and pixel values (Value) 815.

<Rendering Processing for Tile Instruction>

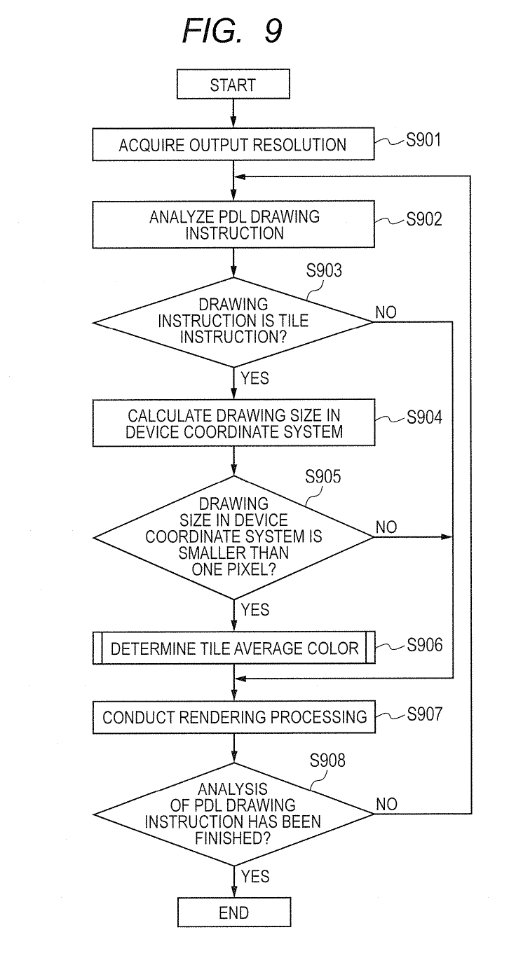

The rendering processing conducted for the drawing instruction described in the PDL data 201 by the information processing apparatus 101 is described. FIG. 9 is a flowchart for illustrating an overall flow of the rendering processing for a tile instruction.

In Step S901, the PDL analysis unit 202 acquires an output resolution. In Step S902, the PDL analysis unit 202 analyzes a drawing instruction described in the PDL data 201. In Step S903, the PDL analysis unit 202 examines whether or not the drawing instruction analyzed in Step S902 is a tile instruction. When the drawing instruction is the tile instruction, the processing advances to Step S904, and otherwise advances to Step S907.

In Step S904, the PDL analysis unit 202 uses information on the output resolution acquired in Step S901 and the drawing instruction acquired in Step S902 to calculate the drawing size of the tile instruction in the device coordinate system. In Step S905, the PDL analysis unit 202 determines whether or not the drawing size calculated in Step S904 is smaller than one pixel. When the drawing size is smaller than one pixel, the processing advances to Step S906, and otherwise advances to Step S907.

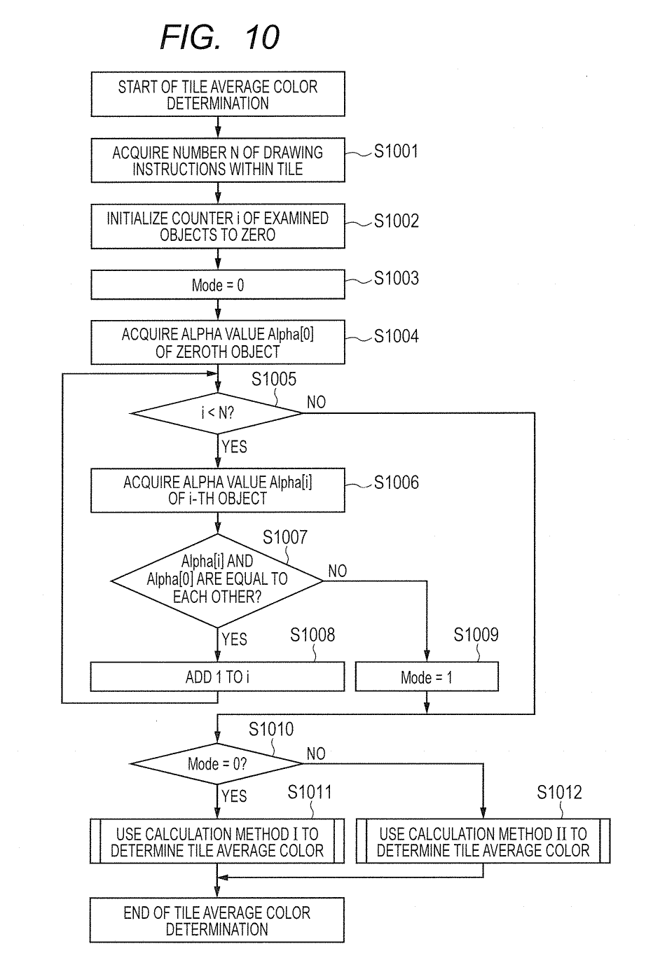

In Step S906, the tile average color calculation unit 203 calculates a tile average color, and replaces the tile instruction by a fill instruction using the calculated average color. This processing is described in detail with reference to FIG. 10. In Step S907, the rendering unit 204 renders the drawing instruction to generate the RIP result 205. In Step S908, the PDL analysis unit 202 examines whether or not the analysis of the PDL drawing instruction has been finished. When the analysis has been finished, the processing is brought to an end, and otherwise returns to Step S902.

<Details of Tile Average Color Determining Processing>

FIG. 10 is a flowchart for illustrating details of tile average color determining processing conducted in Step S906 of FIG. 9. In this embodiment, a plurality of tile average color calculation methods are provided, and it is determined which of the tile average color calculation methods is to be used based on specific conditions described below.

In Step S1001, the tile average color calculation unit 203 acquires a number N of drawing instructions included in the tile drawing. Subsequently, in Step S1002, the tile average color calculation unit 203 initializes a counter i for counting the number of examined drawing instructions within the tile drawing to zero, and in Step S1003, initializes a variable Mode representing a mode of the tile average color calculation method to zero.

In Step S1004, the tile average color calculation unit 203 acquires an alpha value Alpha[0] held by the zeroth drawing instruction included in the tile drawing. In Step S1005, the tile average color calculation unit 203 compares the values between the counter i and N. When the counter i is smaller than N, Step S1006 is conducted, and otherwise Step S1010 is conducted.

In Step S1006, the tile average color calculation unit 203 acquires an alpha value Alpha[i] held by the i-th drawing instruction included in the tile drawing. In Step S1007, the tile average color calculation unit 203 compares the values between Alpha[0] acquired in Step S1004 and Alpha[i] acquired in Step S1006. When the values are equal to each other, Step S1008 is conducted, and otherwise Step S1009 is conducted. In Step S1008, the tile average color calculation unit 203 adds one to the value of the counter i, and returns to Step S1005.

In Step S1009, the tile average color calculation unit 203 sets the variable Mode representing the mode of the tile average color calculation method to one. When the processing from Step S1004 to Step S1009 is conducted for the unit tile of FIG. 6A, the variable Mode is zero in Step S1010 because the above-mentioned unit tile is formed of only the fills having the same alpha value. When the processing from Step S1004 to Step S1009 is conducted for the unit tile of FIG. 6B, the variable Mode is one in Step S1010 because the above-mentioned unit tile is formed of fills having different alpha values.

In Step S1010, the tile average color calculation unit 203 examines whether or not the value of the variable Mode representing the mode of the tile average color calculation method is zero. When the variable Mode is zero, Step S1011 is conducted, and otherwise Step S1012 is conducted. In Step S1011, the tile average color calculation unit 203 uses a calculation method I to determine the tile average color, and in Step S1012, uses a calculation method II to determine the tile average color.

<Tile Average Color Determining Processing Using Calculation Method I>

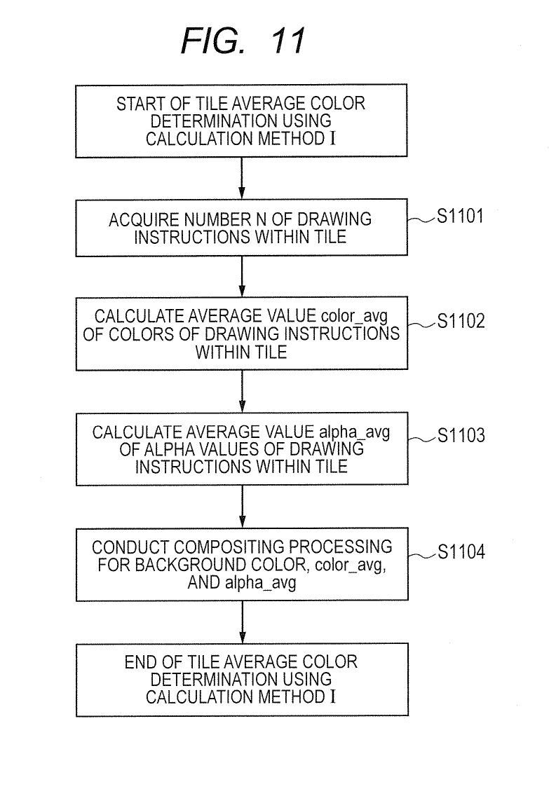

FIG. 11 is a flowchart for illustrating details of the processing of Step S1011 of FIG. 10. In this processing, N represents the number of drawing instructions included in the tile drawing, and i represents a counter for counting the number of examined drawing instructions within the tile drawing.

In Step S1101, the tile average color calculation unit 203 acquires the number N of drawing instructions included in the tile drawing. In Step S1102, the tile average color calculation unit 203 calculates an average value color_avg of the colors of the drawing instructions included in the tile drawing. A calculation expression for the average value color_avg is as follows:

$$color\_avg = \frac{{\sum }_{i = 0}^{N - 1} color [ i ]}{N}$$

where color[i] represents the color value of the i-th drawing instruction included in the tile drawing.

In Step S1103, the tile average color calculation unit 203 calculates an average value alpha_avg of the alpha values of the drawing instructions included in the tile drawing. A calculation expression for the average value alpha_avg is as follows:

$$alpha\_avg = \frac{{\sum }_{i = 0}^{N - 1} alpha [ i ]}{N}$$

where alpha[i] represents the alpha value of the i-th drawing instruction included in the tile drawing.

In Step S1104, the tile average color calculation unit 203 conducts compositing processing for a background color color_bg, the average value color_avg calculated in Step S1102, and the average value alpha_avg calculated in Step S1103, and sets a result composite_result of the compositing as the tile average color. A calculation expression for the compositing processing is as follows.

composite_result=color_avg*alpha_avg+color_bg*(1−alpha_avg)

<Tile Average Color Determining Processing Using Calculation Method II>

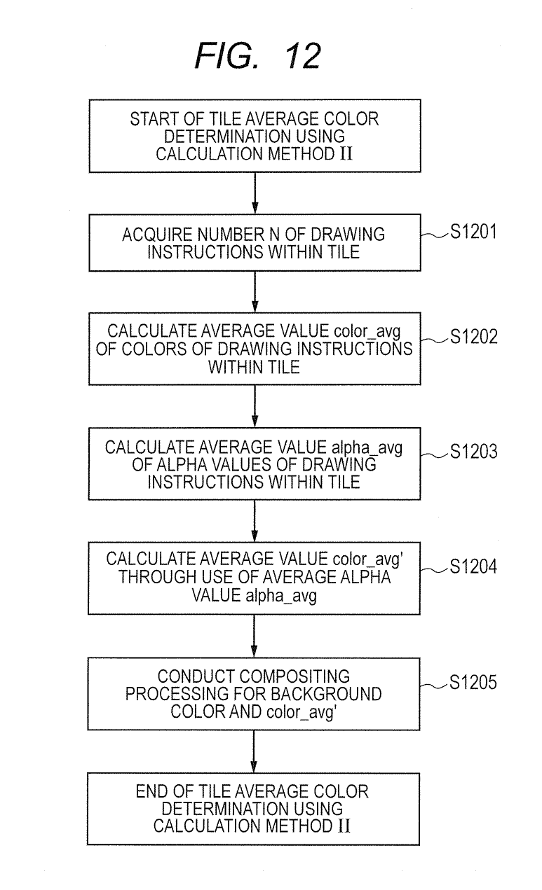

FIG. 12 is a flowchart for illustrating details of the processing of Step S1012 of FIG. 10. In this processing, N represents the number of drawing instructions included in the tile drawing, and i represents the counter for counting the number of examined drawing instructions within the tile drawing. The processing from Step S1201 to Step S1203 is the same as the processing from Step S1101 to Step S1103, respectively, of FIG. 11, and hence a description thereof is omitted.

In Step S1204, the tile average color calculation unit 203 uses the average value alpha_avg calculated in Step S1203 to calculate an average value color_avg′ after correction. A calculation expression for the average value color_avg′ is as follows.

$${color\_avg}^{′} = \frac{color\_avg}{alpha\_avg}$$

In Step S1205, the tile average color calculation unit 203 conducts compositing processing for the background color color_bg and the average value color_avg′ calculated in Step S1204, and sets a result composite result of the compositing as the tile average color. A calculation expression for the compositing processing is as follows.

composite_result=color_avg′*alpha_avg+color_bg*(1−alpha_avg)

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-023639, filed Feb. 10, 2016, which is hereby incorporated by reference herein in its entirety.

What is claimed is:

1. An information processing apparatus, comprising:
a PDL analysis unit configured to acquire an output resolution of input PDL data when a tile drawing instruction is included in the PDL data, and to calculate a drawing size of a tile drawing based on the tile drawing instruction and the output resolution;
an average color calculation unit configured to calculate an average color of the tile drawing based on the tile drawing instruction when the calculated drawing size is smaller than a predetermined value; and
a rendering unit configured to render the tile drawing instruction based on the calculated average color,
wherein the average color calculation unit is configured to calculate the average color based on a transparency level of a unit tile included in the tile drawing instruction.

2. The apparatus according to claim 1, wherein the average color calculation unit is configured to switch a calculation method for the average color based on a value of the transparency level.

3. The apparatus according to claim 1, wherein the average color calculation unit is configured to switch a calculation method for the average color based on whether or not the transparency level is uniform.

4. The apparatus according to claim 1, wherein the average color calculation unit is configured to calculate, when the transparency level is uniform, the average color based on an average value of colors included in the tile drawing instruction, an average value of the transparency level, and a background color.

5. The apparatus according to claim 1, wherein the average color calculation unit is configured to correct, when the transparency level is not uniform, an average value of colors included in the tile drawing instruction through use of an average value of the transparency level, and to calculate the average color based on the corrected average value of the colors, the average value of the transparency level, and a background color.

6. The apparatus according to claim 1, wherein the PDL data comprises data based on an XML paper specification (XPS).

7. The apparatus according to claim 1, wherein the PDL data comprises data based on a portable document format (PDF).

8. An information processing method, comprising:
acquiring an output resolution of input PDL data when a tile drawing instruction is included in the PDL data, and calculating a drawing size of a tile drawing based on the tile drawing instruction and the output resolution;
calculating an average color of the tile drawing based on the tile drawing instruction when the calculated drawing size is smaller than a predetermined value; and
rendering the tile drawing instruction based on the calculated average color,
wherein the calculating of the average color comprises calculating the average color based on a transparency level of a unit tile included in the tile drawing instruction.

9. A non-transitory computer-readable recording medium having recorded thereon a program for causing a computer to execute an information processing method, the information processing method comprising:
acquiring an output resolution of input PDL data when a tile drawing instruction is included in the PDL data, and calculating a drawing size of a tile drawing based on the tile drawing instruction and the output resolution;
calculating an average color of the tile drawing based on the tile drawing instruction when the calculated drawing size is smaller than a predetermined value; and
rendering the tile drawing instruction based on the calculated average color,
wherein the calculating of the average color comprises calculating the average color based on a transparency level of a unit tile included in the tile drawing instruction.
